(19) United States
(12) Patent Application Publication
(10) Pub. No.: US 2026/0093989 A1
(43) Pub. Date: Apr. 2, 2026

(54) ELECTRONIC DEVICE, TERMINAL, AND OPERATING METHOD WITH NEURAL NETWORK LIGHTWEIGHTING

(71) Applicants: SAMSUNG ELECTRONICS CO., LTD., Suwon-si (KR); SEOUL NATIONAL UNIVERSITY R&DB FOUNDATION, Seoul (KR)

(72) Inventors: Jinuk KIM, Yongin-si (KR); Hyun Oh SONG, Seoul (KR)

(73) Assignees: SAMSUNG ELECTRONICS CO., LTD., Suwon-si (KR); SEOUL NATIONAL UNIVERSITY R&DB FOUNDATION, Seoul (KR)

(21) Appl. No.: 19/329,970

(22) Filed: Sep. 16, 2025

(30) Foreign Application Priority Data
Oct. 2, 2024 (KR) 10-2024-0134316

(51) Int. Cl. G06N 3/082; G06N 3/0464

(52) U.S. Cl. CPC G06N 3/082; G06N 3/0464

(57) ABSTRACT

An electronic device includes one or more processors configured to generate a plurality of candidate neural networks in which one or more nonlinear layers are excluded from a neural network including a plurality of segments, each of the plurality of segments including a nonlinear layer and a convolution layer, select one candidate neural network from the plurality of candidate neural networks based on an importance value and a latency value for a succession segment included in each of the plurality of candidate neural networks where convolution layers are successive, and generate a final neural network in which the successive convolution layers are merged in the selected candidate neural network.

### CROSS-REFERENCE TO RELATED APPLICATIONS

This application claims the benefit under 35 USC § 119 (a) of Korean Patent Application No. 10-2024-0134316, filed on Oct. 2, 2024 in the Korean Intellectual Property Office, the entire disclosure of which is incorporated herein by reference for all purposes.

### BACKGROUND

### 1. Field

The following description relates to an electronic device, terminal, and operating method with neural network lightweighting.

### 2. Description of the Related Art

An artificial neural network (hereinafter referred to as “neural network”) is a machine learning model for processing data and learning patterns. The neural network may include multiple layers including nodes, and may be trained using a relationship between the inputs and outputs while processing data repeatedly. The neural network may be used in various areas such as image recognition, image generation, voice recognition, voice generation, natural language processing, and large language models.

The depth of neural networks may increase as the number of the layers increases, and the performance of the neural network (e.g., output accuracy) may be enhanced as the depth of the neural network increases. However, computational complexity may increase as the depth of the neural network increases, thereby increasing consumption of computational resources and inference time.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, an electronic device includes one or more processors configured to generate a plurality of candidate neural networks in which one or more nonlinear layers are excluded from a neural network including a plurality of segments, each of the plurality of segments including a nonlinear layer and a convolution layer, select one candidate neural network from the plurality of candidate neural networks based on an importance value and a latency value for a succession segment included in each of the plurality of candidate neural networks where convolution layers are successive, and generate a final neural network in which the successive convolution layers are merged in the selected candidate neural network.

The plurality of candidate neural networks may include a candidate neural network in which a predetermined convolution layer is excluded from a plurality of convolution layers included in the succession segment according to a kernel size that is set for the succession segment.

For the selecting of the one candidate neural network from the plurality of candidate neural networks, the one or more processors may be configured to identify one or more convolution layers among the plurality of convolution layers included in the succession segment by comparing the kernel size which is set for the succession segment with kernel sizes of the plurality of convolution layers included in the succession segment, identify a representative layer of the succession segment based on the identified convolution layer, and select a candidate neural network from among the plurality of candidate neural networks, in which the plurality of convolution layers included in the succession segment are replaced with the representative layer, based on a sum of latency values for the succession segment and a non-succession segment in each candidate neural network being below a threshold value, and a sum of importance values for the succession segment and the non-succession segment being largest.

For the identifying of the representative layer, the one or more processors may be configured to generate, in response to identifying two or more convolution layers from the plurality of the convolution layers included in the succession segment, a merged layer into which the selected convolution layers are merged as the representative layer.

The one or more processors may be configured to generate, in response to identifying only one convolution layer from the plurality of convolution layers included in the succession segment, the selected convolution layer as the representative layer.

The one or more processors may be configured to, in response to the kernel sizes of the plurality of convolution layers included in the succession segment being equal, select a convolution layer in sequential order from a largest value among respective sums of weight values included in the plurality of convolution layers, and exclude a convolution layer other than the selected convolution layer from the succession segment.

The importance value for the succession segment of each candidate neural network may be set based on output accuracy of each candidate neural network and a variation of the output accuracy of the neural network.

The importance value for the succession segment of each candidate neural network may be set to have a larger value as the variation for the succession segment decreases.

The latency value for the succession segment may be set based on a time consumed to execute the succession segment, and a latency value for the non-succession segment may be set based on a time consumed to execute the non-succession segment.

The one or more processors may be configured to adjust a weight value included in the convolution layer by retraining the selected candidate neural network or the final neural network.

The final neural network may be a target lightweight neural network corresponding to profile information among a plurality of lightweight neural networks having different degrees of lightweighting a layer in the neural network and different latencies, and the one or more processors may be configured to obtain inferential data based on the target lightweight neural network.

In one or more general aspects, a processor-implemented method includes generating a plurality of candidate neural networks in which one or more nonlinear layers are excluded from a neural network including a plurality of segments, each of the plurality of segments including a nonlinear layer and a convolution layer, selecting one candidate neural network from the plurality of candidate neural networks based on an importance value and a latency value for a succession segment included in each of the plurality of candidate neural networks where convolution layers are successive, and generating a final neural network in which the successive convolution layers are merged in the selected candidate neural network.

The plurality of candidate neural networks may include a candidate neural network in which a predetermined convolution layer is excluded from a plurality of convolution layers included in the succession segment according to a kernel size which is set for the succession segment.

The selecting of the one candidate neural network from the plurality of candidate neural networks may include identifying one or more convolution layers among the plurality of convolution layers included in the succession segment by comparing the kernel size which is set for the succession segment with kernel sizes of the plurality of convolution layers included in the succession segment, identifying a representative layer of the succession segment based on the identified convolution layer, and selecting a candidate neural network from among the plurality of candidate neural networks, in which the plurality of convolution layers included in the succession segment are replaced with the representative layer, based on a sum of latency values for the succession segment and a non-succession segment in each candidate neural network being below a threshold value, and a sum of importance values for the succession segment and the non-succession segment being largest.

The identifying of the representative layer may include generating, in response to identifying two or more convolution layers from the plurality of the convolution layers included in the succession segment, a merged layer into which the selected convolution layers are merged as the representative layer.

The identifying of the representative layer may include identifying, in response to identifying only one convolution layer from the plurality of convolution layers included in the succession segment, the selected convolution layer as the representative layer.

The identifying of the one or more convolution layers from the plurality of convolution layers included in the succession segment may include, in response to the kernel sizes of the plurality of the convolution layers included in the succession segment being equal, selecting a convolution layer in sequential order from a largest value among values of respective sums of weight values included in the plurality of convolution layers, and excluding a convolution layer other than the selected convolution layer from the succession segment.

The method may include obtaining a value that is set based on output accuracy of each candidate neural network and a variation of the output accuracy of the neural network as the importance value for the succession segment of each candidate neural network.

The importance value for the succession segment of each candidate neural network may be set to have a larger value as the variation for the succession segment decreases.

The method may include obtaining a value that is set based on a time consumed to determine each of the succession segment and the non-succession segment as a latency value for each of the succession segment and the non-succession segment.

The method may include adjusting a weight value included in the convolution layer by retraining the selected candidate neural network or the final neural network.

In one or more general aspects, a terminal for communicating with an electronic device that stores a neural network includes a transceiver configured to receive and transmit information to and from the electronic device, and one or more processors configured to generate a target lightweight neural network corresponding to profile information among a plurality of lightweight neural networks having different degrees of lightweighting a layer in the neural network and different latencies, and obtain inferential data based on the target lightweight neural network.

The profile information may include one of pieces of user information corresponding to one access level among a plurality of access levels assigned based on performance information on performance of the terminal and fee rates.

The one or more processors may be configured to generate, in response to the performance of the terminal included the profile information corresponding to a first level, a first lightweight neural network that has a smaller latency than a threshold value corresponding to the first level among the plurality of lightweight neural networks as the target lightweight neural network, and generate, in response to the performance corresponding to a second level that is higher than the first level, a second lightweight neural network that has a smaller latency than a threshold value corresponding to the second level among the plurality of lightweight neural networks as the target neural network, and the second lightweight neural network may have higher inference performance than that of the first lightweight neural network.

The one or more processors may be configured to receive, in response to the access level of the terminal included the profile information corresponding to a first level, a first lightweight neural network corresponding to the first level among the plurality of lightweight neural networks as the target lightweight neural network, and receive, in response to the access level corresponding to a second level that is higher than the first level, a second lightweight neural network among the plurality of lightweight neural networks as the target lightweight neural network, and the second lightweight neural network has higher inference performance than that of the first lightweight neural network.

The terminal may include a memory, wherein the performance of the terminal may include either one or both of a load of the one or more processors and a storage capacity of the memory.

The one or more processors may be configured to generate a plurality of candidate neural networks from which one or more nonlinear layers is excluded and that may include a merged layer into which convolution layers of a segment succeeding or succeeded by a segment from which the nonlinear layer is excluded are merged, generate one threshold value for a plurality of threshold values that are different from each other, and generate, as a lightweight neural network corresponding to the threshold value, a candidate neural network with a highest inference performance and a latency smaller than the threshold value among the plurality of candidate neural networks.

The terminal may include a memory configured to store the lightweight neural network.

The one or more processors may be configured to control the transceiver to transmit the profile information to the electronic device, and receive, through the transceiver, the target lightweight neural network corresponding to the profile information among the plurality of lightweight neural network which are stored in the electronic device.

Other features and aspects will be apparent from the following detailed description, the drawings, and the claims.

### BRIEF DESCRIPTION OF THE DRAWINGS

FIG. 1 is a block diagram illustrating an electronic device according to one or more embodiments;

FIG. 2 is a diagram illustrating a neural network according to one or more embodiments;

FIG. 3 is a diagram illustrating a nonlinear layer according to one or more embodiments;

FIG. 4 is a diagram illustrating a convolution layer according to one or more embodiments;

FIG. 5 is a diagram illustrating a candidate neural network according to one or more embodiments;

FIG. 6 is a diagram illustrating a process of lightweighting a neural network according to one or more embodiments;

FIG. 7 is a diagram illustrating an operating method for neural network lightweighting according to one or more embodiments;

FIG. 8 is a diagram illustrating an operating method for neural network lightweighting according to an one or more embodiment;

FIG. 9 is a block diagram illustrating a terminal according to one or more embodiments; and

FIG. 10 is a diagram illustrating data flow according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C”, and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

Throughout the specification, when a component or element is described as “on,” “connected to,” “coupled to,” or “joined to” another component, element, or layer, it may be directly (e.g., in contact with the other component, element, or layer) “on,” “connected to,” “coupled to,” or “joined to” the other component element, or layer, or there may reasonably be one or more other components elements, or layers intervening therebetween. When a component or element is described as “directly on,” “directly connected to,” “directly coupled to,” or “directly joined to” another component element, or layer, there can be no other components, elements, or layers intervening therebetween. Likewise, expressions, for example, “between” and “immediately between” and “adjacent to” and “immediately adjacent to” may also be construed as described in the foregoing.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” to specify the presence of stated features, numbers, operations, members, elements, and/or combinations thereof, other embodiments may exist where one or more of the stated features, numbers, operations, members, elements, and/or combinations thereof are not present.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application, and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto. The use of the terms “example” or “embodiment” herein have a same meaning (e.g., the phrasing “in one example” has a same meaning as “in one embodiment,” and “one or more examples” has a same meaning as “in one or more embodiments”).

Although terms such as “first,” “second,” and “third,” or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but is used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

In the following description, example embodiments of the present disclosure will be described in detail with reference to the drawings so that those skilled in the art can easily carry out the present disclosure. The present disclosure may be embodied in many different forms and is not limited to the example embodiments described herein.

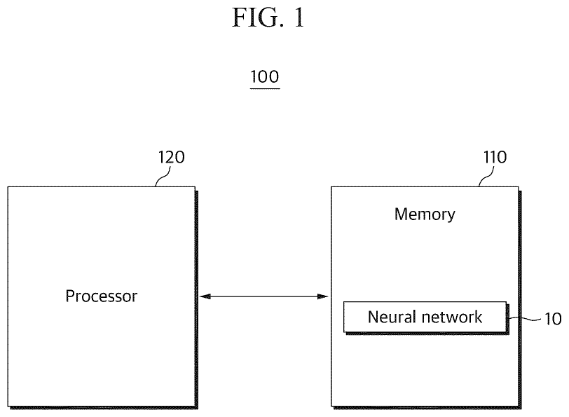

FIG. 1 is a block diagram illustrating an electronic device according to one or more embodiments.

An electronic device of one or more embodiments may perform neural network lightweighting of a neural network while maintaining a performance of the neural network. Referring to FIG. 1, an electronic device 100 may implement an operating method for neural network lightweighting. According to example embodiments, the electronic device 100 may be a computer, a server, a data center, a neural network training device, a smartphone, a tablet, and others. In example embodiments, the operating method for the neural network lightweighting may be a method for reducing depth of a neural network 10. For example, the operating method of one or more embodiments for neural network lightweighting may accelerate inference speed while minimizing performance variation (e.g., performance variation of an output) of a neural network with reduced depth. Hereinafter, example embodiments of the present disclosure will be described in detail.

The electronic device 100 according to example embodiments may include a memory 110 (e.g., one or more memories) and a processor 120 (e.g., one or more processors). The memory 110 and the processor 120 may be connected to each other by a communication bus.

The memory 110 may store data. For example, the memory 100 may include at least one storage device from various kinds of storage devices such as a random-access memory (RAM), a high bandwidth memory (HBM), a flash memory, a hard disk drive, a solid-state drive, and a cache memory.

The memory 110 may store the neural network 10. The neural network 10 may be used to process various data such as image recognition, image processing, image generation, voice recognition, voice generation, natural language processing, machine translation, and automatic driving, as non-limiting examples.

In example embodiments, the neural network 10 may be an artificial neural network that has learned data patterns based on learning data. For example, the neural network 10 may be an artificial neural network that is already trained. Output data of input data may be obtained through the neural network 10. The output data may be data inferred or predicted from the input data. The neural network 10 may be a convolution neural network. In example embodiments, the neural network 10 may be trained by the processor 120 and stored in the memory 110. In another example embodiment, the neural network 10 may be trained by an external device and stored in the memory 110.

The neural network 10 may include a plurality of layers. A layer may define operations of data. A connection relationship between layers may indicate an operation order of the data. The plurality of layers may include a plurality of convolution layers and a plurality of nonlinear layers. Meanwhile, the neural network 10 may include a plurality of segments. Each of the plurality of segments may include a convolution layer and a nonlinear layer. The plurality of convolution layers and the plurality of nonlinear layers may be repeatedly and alternately arranged. For example, one nonlinear layer may be interposed between a predetermined convolution layer and a following convolution layer. Data may be processed according to an arrangement order of the layers.

The processor 120 may control overall operations of the electronic device 100 or perform an operation. For example, the processor 120 may execute a program or an instruction stored in the memory 110. The processor 120 may process data stored in the memory 110 (e.g., the neural network 10) or perform an operation. For example, the memory 110 may be or include a non-transitory computer-readable storage medium storing code that, when executed by the processor 120, configures the processor 120 to perform any one, any combination, or all of operations and/or methods disclosed herein with reference to FIGS. 1-10. The processor 120 may be in the form of various processing devices such as a central processing unit (CPU), a graphic processing unit (GPU), a neural processing unit (NPU), a micro controller unit (MCU), and an application processor (AP). The processor 120 may be configured to implement the functions and methods described herein with reference to FIGS. 1 through 10.

The processor 120 may obtain a plurality of candidate neural networks in which at least one nonlinear layer is excluded from the neural network 10 (e.g., a plurality of candidate neural networks not including at least one nonlinear layer included in the neural network 10). When a nonlinear layer is removed from (e.g., excluded from or not included in) the neural network 10, as in the plurality of candidate neural networks, a succession segment (or a continuous segment) with successive convolution layers (or consecutive convolution layers) may occur. The plurality of candidate neural networks may be a subset including remaining layers included in the neural network 10, partially excluding one or more of the layers included in the neural network 10. At least one of layers included in one of the plurality of candidate neural networks may be different from that of another one of the candidate neural networks. In example embodiments, the processor 120 may identify a plurality of candidate neural networks in which at least one nonlinear layer is excluded from the neural network 10 and the successive convolution layers are merged.

The processor 120 may select one candidate neural network from the plurality of candidate neural networks based on an importance value and a latency value of the succession segment in which the convolution layers are successive among a plurality of segments included in each of the plurality of the candidate neural networks. For example, in the case when some of layers of a succession segment of a candidate neural network (or the original neural network 10) are changed, the importance value for the succession segment may correspond to output accuracy of the candidate neural network and a variation of output accuracy of the original neural network 10. In the case when some layers of the succession segment are changed, the latency value for the succession segment may correspond to a time consumed to execute the succession segment (e.g., a time consumed to process data using the succession segment). Determination of the succession segment may be performed by the processor 120. The importance value and the latency value for the succession segment may be stored in the memory 110.

The processor 120 may obtain (e.g., generate) a final neural network in which successive convolution layers are merged in the selected candidate neural network. For example, the processor 120 may obtain the final neural network by removing a layer other than layers included in the selected candidate neural network from the neural network 10 and merging the successive convolution layers.

In example embodiments, the electronic device 100 may further include a transceiver (not shown) for communicating with an external device. The transceiver may receive and transmit various data to and from the external device (e.g., a terminal). For example, the transceiver may transmit the final neural network to the external device. Also, the transceiver may receive profile information from the external device.

According to example embodiments, the electronic device 100 of one or more embodiments may improve (e.g., accelerate or increase) the inference speed while maintaining output performance (or inference performance) by pruning a convolution layer and a nonlinear layer of the neural network 10 together. In an example embodiment, the electronic device 100 of one or more embodiments may enhance safety and efficiency of a Full Self-Driving system by accelerating the neural network 10 implemented to the Full Self-Driving system and processing a large amount of data in real time. In an example embodiment, the electronic device 100 of one or more embodiments may improve accuracy of medical diagnosis may by accelerating the neural network 10 implemented to the medical system and analyzing images for medical diagnosis in real time. In an example embodiment, the electronic device 100 of one or more embodiments may increase the inference speed by improving efficiency of operations by lightweighting the neural network 10 from a mobile device or embedded system with limited computing resources or others. Hereinafter, example embodiments of the present disclosure will be described in further detail with reference to the drawings.

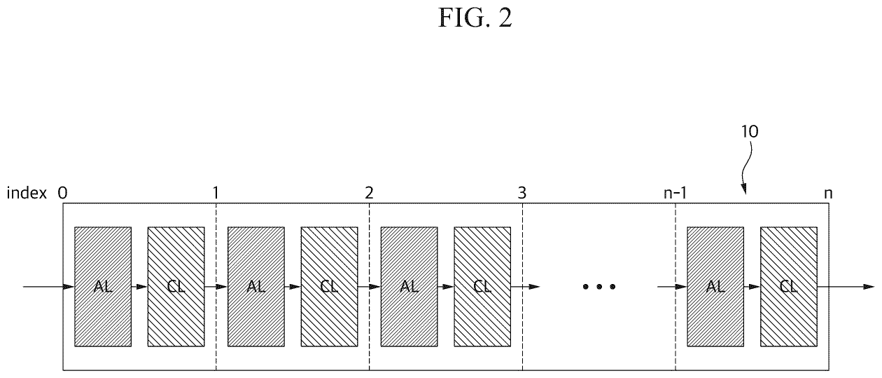

FIG. 2 is a diagram illustrating a neural network according to one or more embodiments.

Referring to FIG. 2, the neural network 10 according to example embodiments may include a plurality of segments. The plurality of segments may be sequentially arranged or connected. For example, the plurality of segments may include a first segment between indexes 0 to 1, a second segment between indexes 1 to 2, a third segment between indexes 2 to 3, and an n-th segment between indexes n−1 to n with “n” being a natural number. Accordingly, when first input data is input to the first segment, first output data for (e.g., generated based on) the first input data may be outputted through one or more operations of a layer included in the first segment. The first output data of the first segment may be used as second input data for the second segment that follows the first segment. Through repetition of the process, n-th output data may be output from the n-th segment. However, the number of the segments may be varied.

Each of the plurality of segments may include a nonlinear layer AL and a convolution layer CL. A plurality of convolution layers and a plurality of nonlinear layers included in the neural network 10 may be repeatedly and alternately arranged. For example, one nonlinear layer may be interposed between a predetermined convolution layer and a following convolution layer. For example, each segment may have an identical connection order of the nonlinear layer AL and the convolution layer CL included therein. As an example, the nonlinear layer AL and the convolution layer CL may be arranged in sequence from the nonlinear layer AL to the convolution layer CL in each segment. As another example, the nonlinear layer AL and the convolution layer CL may be arranged in sequence from the convolution layer CL to the nonlinear layer AL in each segment.

Meanwhile, the processor 120 may obtain a plurality of candidate neural networks based on the neural network 10. For example, a first candidate neural network may be a candidate neural network in which the nonlinear layer AL of the second segment is excluded from the neural network 10. A second candidate neural network may be a candidate neural network in which the nonlinear layer AL of the third segment is excluded from the neural network 10. A third candidate neural network may be a candidate neural network in which the nonlinear layer AL of the second segment and the third segment is excluded from the neural network 10. A fourth candidate neural network may be a candidate neural network in which the nonlinear layer AL of the second segment and the third segment and the convolution layer CL of the second segment are excluded from the neural network 10. The plurality of candidate neural networks may be obtained according to various combinations in which a layer (e.g., one or more nonlinear layers) is excluded from the neural network 10.

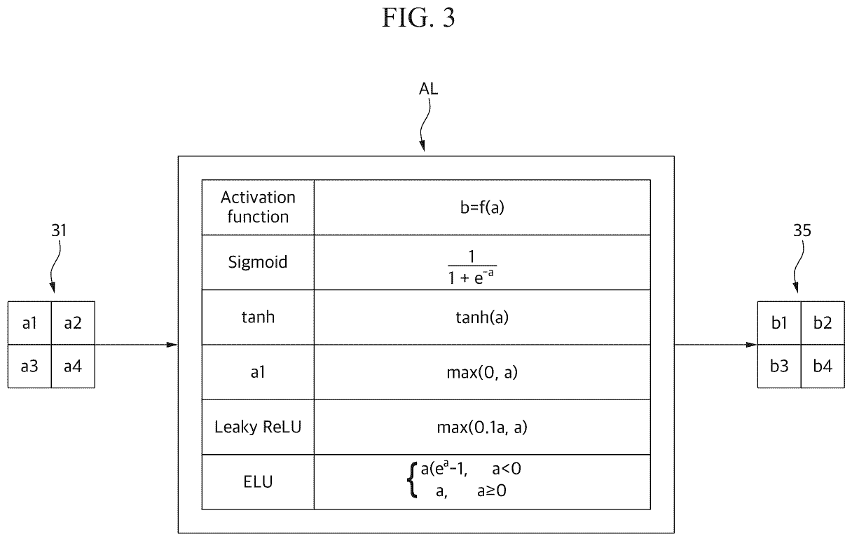

FIG. 3 is a diagram illustrating a nonlinear layer according to one or more embodiments.

Referring to FIG. 3, input data 31 may be input to the nonlinear layer AL according to example embodiments. The input data 31 which is input to the nonlinear layer AL may be output data of a directly previous layer (e.g., a convolution layer, another nonlinear layer, or the like) among successive layers or may be input data entered earliest. The input data 31 may include a plurality of input parameters a1 to a4. The input parameters a1 to a4 may be arranged in a matrix. Meanwhile, the number and an arrangement type of the input parameters a1 to a4 are merely an example and may be varied.

The nonlinear layer AL may include an activation function. The activation function may be a function which applies each of the input parameters a1 to a4 of the input data 31 as a variable to obtain each of output parameters b1 to b4 of output data 35. For example, a first output parameter b1 may be a value obtained through an operation of the activation function which applies a first input parameter a1 placed in the same arrangement as the variable. The same scheme may be applied to a different input parameter and output parameter. For example, output parameters b2 to b4 may be generated by respectively applying the activation function to input parameters a2 to a4. For example, the nonlinear layer AL may output the output data 35 corresponding to the input data 31 through the operation of the activation function. For example, the input data 31 may have the same size (e.g., 2×2) as that of the output data 35. In the meantime, the operation of the activation function may be performed by the processor 120.

In example embodiments, the activation function may include at least one of a rectified linear unit (ReLU) function, a Leakey ReLU function, a Sigmoid function, a tanh function, and an exponential linear unit (ELU), as non-limiting examples. For example, the ReLU function may produce an output that is the same as an input when the input is a positive number or produce “O” when the input is a negative number. The Leakey ReLU function may produce an output that is the same as an input when the input is a positive number or produce an output by multiplying the input by a small gradient value when the input is a negative number. The Sigmoid function may be a function which limits an output value to a value within a predetermined range (e.g., from 0 to 1). The tanh function may be a function which limits an output value to a value within a predetermined range (e.g., from −1 to 1). An ELU function may produce an output that is the same as an input when the input is a positive number or produce an output as an exponential function value when the input is a negative number. According to example embodiments, the activation function may add nonlinearity to data.

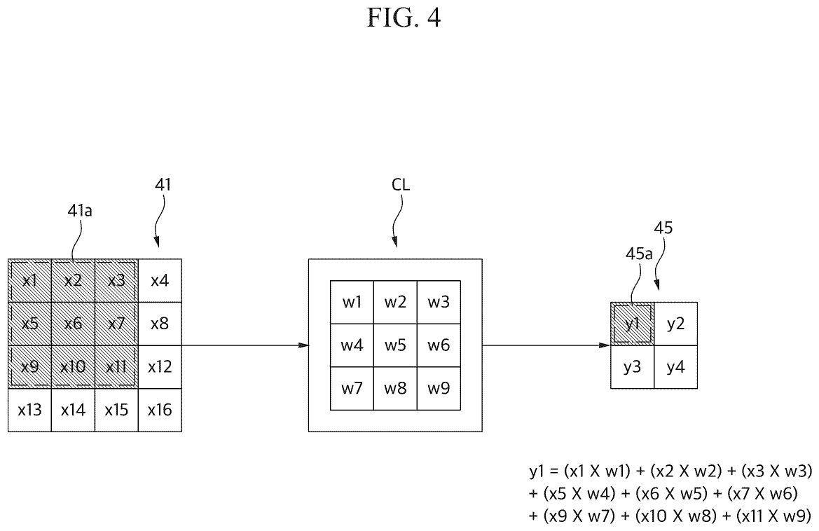

FIG. 4 is a diagram illustrating a convolution layer according to one or more embodiments.

Referring to FIG. 4, input data 41 may be input to the convolution layer CL according to example embodiments. The input data 41 input to the convolution layer CL may be output data of a directly previous layer (e.g., a nonlinear layer, another convolution layer, or the like) of successive layers or may be input data entered earliest. The input data 41 may include a plurality of input parameters x1 to x16. The input parameters x1 to x16 may be arranged in a matrix. Meanwhile, the number and an arrangement type of the input parameters x1 to x16 are merely an example and may be varied.

The convolution layer CL may include a kernel (or a filter). The kernel may include a plurality of weight values w1 to w9. For example, the plurality of weight values w1 to w9 may be arranged in a 3×3 matrix. Meanwhile, the number and an arrangement type of the plurality of weight values w1 to w9 are merely an example and may be varied. When the kernel and the input data 41 overlap each other, a convolution operation may be performed using a weight value and an input parameter that are arranged at the same location. Then, a convolution operation may be performed using a weight value and an input parameter arranged at the same location while the kernel and the input data 41 overlap with each other by sliding the kernel in a row or/and column direction, and the same operation may be repeated. Here, the kernel may move by a predetermined stride on the input data 41. For example, when the stride is set to 1, the kernel may move by one column or one row.

For example, in the case of the kernel overlapping with a first input area 41a of the input data 41, when a convolution operation is performed using a weight value and an input parameter arranged at the same location, a first output parameter y1 may be obtained which may be placed at a first output area 45a corresponding to an arrangement of the first input area 41a. Meanwhile, a convolution operation may be performed by the processor 120.

In example embodiments, the neural network 10 may be a trained artificial neural network. A plurality of weight values included in the convolution layer CL of the neural network 10 may be an adjusted value through already performed training. For example, by updating a weight value by a back-propagation algorithm, the device and method of one or more embodiments may increase output accuracy of the neural network 10 (e.g., to minimize a loss function).

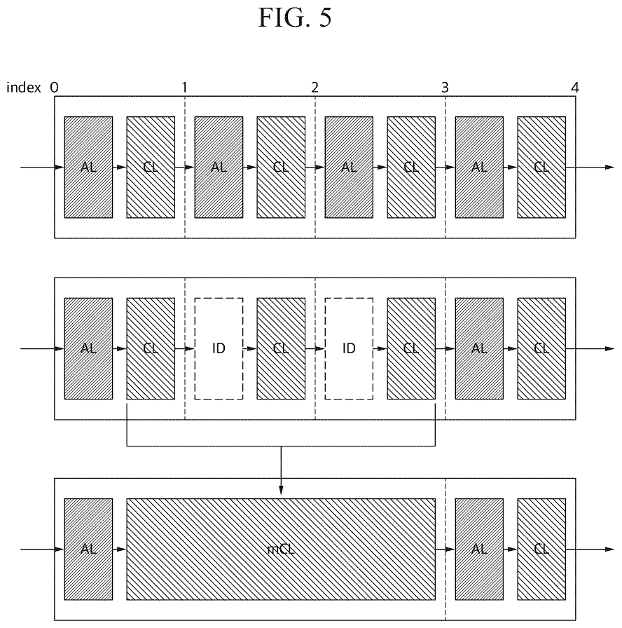

FIG. 5 is a diagram illustrating a candidate neural network according to one or more embodiments.

Referring to FIG. 5, the processor 120 according to example embodiments may obtain the candidate neural network by excluding at least one nonlinear layer AL from the neural network 10. The processor 120 according to example embodiments may obtain the candidate neural network by excluding the at least one nonlinear layer AL and at least one convolution layer CL from the neural network 10. Here, the neural network 10 may include a plurality of segments. Each of the plurality of segments may include the nonlinear layer (AL) and the convolution layer (CL) that are sequentially connected. For example, the plurality of segments may include a first segment between indexes 0 to 1, a second segment between indexes 1 to 2, a third segment between indexes 2 to 3, and a fourth segment between indexes 3 to 4.

In example embodiments, the processor 120 may exclude nonlinear layers AL of the second segment and the third segment of the neural network 10. In example embodiments of the present disclosure, a layer to be excluded (or removed) may be changed to an identity function layer ID. The identity function layer ID may include an identity function that produces an output that is the same as an input. For example, the processor 120 may change the layer at a location to be excluded to the identity function layer ID.

In this case, when the nonlinear layer (AL) does not exist between the convolution layer (CL) of the first segment and the convolution layer (CL) of the second segment, convolution layers (CL) of the first segment and the second segment may be successive convolution layers. In addition, when the nonlinear layer AL does not exist between the convolution layer (CL) of the second segment and the convolution layer CL of the third segment, convolution layers (CL) of the second segment and the third segment may be successive convolution layers. In this case, the first segment to the third segment including one of convolution layers CL of the first segment to the third segment may be a succession segment. For example, the succession segment may include the first segment, the second segment and the third segment. In this case, the succession segment may include the successive convolution layers CL of the first segment to the third segment. Meanwhile, a segment other than the succession segment may be a non-succession segment. For example, the fourth segment may be the non-succession segment.

In example embodiments, the processor 120 may obtain the candidate neural network by excluding the at least one nonlinear layer AL from the neural network 10 and changing the convolution layer CL included in the succession segment to a representative layer. For example, when the nonlinear layers AL of the second segment and the third segment are excluded as illustrated in FIG. 5, the succession segment may include the convolution layers CL of the first segment to the third segment.

In example embodiments, the processor 120 may select at least one convolution layer from a plurality of convolution layers CL included in the succession segment according to a kernel size that is set for the succession segment. The processor 120 may obtain the representative layer of the succession segment based on the selected convolution layer. The processor 120 may replace (or change) the plurality of convolution layers (CL) included in the succession segment with the representative layer.

In example embodiments, the processor 120 may select the at least one convolution layer among the plurality of convolution layers CL included in the succession segment by comparing the kernel size which is set for the succession segment with kernel sizes of the plurality of convolution layers CL included in the succession segment.

For example, a kernel size of a merged layer mCL obtained when the plurality of convolution layers CL are merged may be determined using Equation 1 below, for example.

$$K e r ( \hat{θ} ) = 1 + {\sum }_{l = i}^{j} ( Ker ( {θ}_{l} ) - 1 ) \qquad Equation 1$$

Referring to Equation 1, θₗ may denote a weight value or a parameter of a kernel of a first convolution layer. \hat{θ} may denote a weight value or a parameter of a kernel of the merged layer mCL. For example, the weight value for the kernel of the merged layer mCL may be obtained according to a convolution such as \hat{θ}=θⱼ* . . . * θᵢ. “Ker( )” may be a function for outputting the kernel size. Here, “i” and “j” are natural numbers and “i” may be a value smaller than “j”. Also, “i” and “j” may be an index indicating a location (or segment).

For example, when a weight value for the convolution layer CL includes a kernel arranged in an n×n matrix, a kernel size of the convolution layer CL may be “n”. Here, “n” may be an odd number such as 1, 3, 5, or the like.

In example embodiments, it may be assumed that a kernel size of each of the convolution layer CL of the first segment, the convolution layer CL of the second segment, and the convolution layer CL of the third segment, which are included in the succession segment, is 3. Here, the kernel size of the merged layer mCL into which two of the convolution layers CL of the first segment to the third segment are merged may be 5, and the kernel size of the merged layer mCL into which three of the convolution layers CL of the first to the third segments are merged may be 7.

In example embodiments, the processor 120 may select the at least one convolution layer from the plurality of convolution layers CL included in the succession segment by comparing the kernel size which is set for the succession segment with the kernel size of the merged layer mCL into which the plurality of convolution layers CL included in the succession segment may be merged.

In example embodiments, when at least two convolution layers are selected from the plurality of convolution layers CL included in the succession segment, the processor 120 may obtain a merged layer into which the selected convolution layers are merged as the representative layer. In example embodiments, when one convolution layer is selected from the plurality of convolution layers CL included in the succession segment, the processor 120 may obtain the selected convolution layer as the representative layer. For example, when a kernel size is set for the succession segment, the processor 120 may select and merge a number of convolution layers among the plurality of convolution layers CL included in the succession segment such that the representative layer of the succession segment obtained by the merging has a kernel size equal to the set kernel size.

As an example, when the kernel size which is set for the succession segment is 7, the processor 120 may select and merge three convolution layers among the plurality of convolution layers CL included in the succession segment and obtain the merged layer mCL with a kernel size of 7 as the representative layer of the succession segment.

As another example, when the kernel size which is set for the succession segment is 5, the processor 120 may select and merge two convolution layers among the plurality of convolution layers CL included in the succession segment and obtain the merged layer mCL with a kernel size of 5 as the representative layer of the succession segment.

As still another example, when the kernel size which is set for the succession segment is 3, one convolution layer CL with a kernel size of 3 among the plurality of convolution layers CL included in the succession segment may be identified as the representative layer.

In this case, in the candidate neural network, the convolutional layers CL of the first segment to the third segment included in the succession segment may be changed into the representative layer based on the convolution layer CL selected from the succession segment. A predetermined convolution layer CL may be excluded from the succession segment of the candidate neural network. For example, the excluded convolution layer CL may include the convolution layer CL which is unselected depending on the kernel size. The representative layer may be a merged layer mCL into which at least two convolution layers CL are merged or may be one convolution layer CL.

In example embodiments, when the kernel sizes of the plurality of convolution layers CL included in the succession segment are equal, the processor 120 may select the convolution layer in sequential order from a largest value among values of respective sums of weight values included in the plurality of convolution layers.

For example, when the kernel size of each of the convolution layers CL of the first segment to the third segment is 3 and when the kernel size which is set for the succession segment is 5, the processor 120 may select two convolution layers among the plurality of convolution layers CL included in the succession segment. At this point, the processor 120 may compare a value of a sum of nine weight values of each of the convolution layers CL of the first segment to the third segment with another to select and merge the two convolution layers in sequential order from a largest value among values of respective sums of weight values. For example, the convolution layer CL which has a smallest value among the values of the respective sums of the weight values may not be selected. In this case, the unselected convolution layer CL may be excluded from the candidate neural network including the succession segment. In example embodiments, the excluded convolution layer CL may be changed to the identity function layer ID.

In this manner, from the neural network 10, the processor 120 may obtain a plurality of candidate neural networks in consideration of a segment according to indexes and a kernel size. In example embodiments, the plurality of candidate neural networks may include the candidate neural network in which the convolution layer CL unselected from the plurality of convolution layers CL included in the succession segment is excluded according to the kernel size which is set for the succession segment. For example, the convolution layer CL unelected from the succession segment may be excluded.

In example embodiments, the processor 120 may select a candidate neural network from among the plurality of candidate neural networks, based on a first sum of latency values of the succession segment and the non-succession segment of each candidate neural network being below a threshold value, and a second sum of importance values of the succession segment and the non-succession segment being largest. For example, the processor 120 may determine a first sum of latency values of the succession segment and the non-succession segment for each candidate neural network, determine a second sum of importance values of the succession segment and the non-succession segment for each candidate neural network having a first sum below the threshold value, and select, as a final neural network, a candidate neural network having the largest second sum. For example, each candidate neural network may be a neural network in which a succession segment is formed by selectively excluding one or more nonlinear layers AL from the neural network 10, and the plurality of convolutional layers of the succession segment are replaced with representative layer (e.g., merged layer). Meanwhile, the value of the sum of latency values of the candidate neural network may be referred to as a value of a sum of latencies of the candidate neural network or a latency of the candidate neural network.

In example embodiments, the threshold value may be stored into the memory 110 in advance. In example embodiments, the threshold value may be a value smaller than a value of a sum of latencies of each segment included in the neural network 10. The value of the sum of the latencies of each segment included in the neural network 10 may be a value corresponding to a time consumed to execute (e.g., a time consumed to generate an output based on an input using) the entire neural network 10.

In example embodiments, an importance value for the succession segment of each candidate neural network may be set based on output accuracy of each candidate neural network and a variation of output accuracy of the neural network 10. In example embodiments, the importance value for the succession segment of each candidate neural network may be a value corresponding to the output accuracy of each candidate neural network and the variation of the output accuracy of the neural network 10. For example, the importance value may be determined using Equation 2 below, for example.

$$I [ i , j , k ] := exp ( {max}_{θ} Perf ( {○}_{l = 1}^{L} ( {\underbrace{{σ}_{{\tilde{A}}_{ij , l}}}}_{Replaced act} ◦ {\underbrace{{f}_{{\tilde{C}}_{ij , l} , {θ}_{l} , l}}}_{Replaced conv} ) ) - {max}_{θ} Perf ( {\underbrace{{○}_{l = 1}^{L} ( {σ}_{l} {◦f}_{{θ}_{l}} )}}_{Original network} ) ) \qquad Equation 2$$

Referring to Equation 2, “l” may denote an importance value for a succession segment from “i” to “j”. “k” may denote a kernel size that is set for the succession segment. “k” may denote a kernel size of a representative layer of the succession segment. “l” may denote a value corresponding to output accuracy of a candidate neural network and the variation of the output accuracy of the original neural network 10. For example, “l” may denote a performance variation of an output in the case of replacing the succession segment. σ may denote a nonlinear layer, and “f” may denote a convolution layer. “maxPerf( )” may be a function that outputs output performance (or inference performance, or the output accuracy) of the neural network 10. In example embodiments, “l” may be a value obtained by normalizing output performance of the candidate neural network and a variation of the output performance of the original neural network 10.

In example embodiments, the importance value for the succession segment of each candidate neural network may be set to have a larger value as the variation for the succession segment decreases. In example embodiments, the importance value for the succession segment of each candidate neural network may have the larger value as the variation for the succession segment decreases. As an example, the smaller the variation of the output accuracy is (e.g., the more similar the output performance (or inference performance) of the candidate neural network in which a layer of the succession segment is changed compared to the original neural network 10 is), the higher the importance value for the succession segment may be. As another example, the larger the variation of the output accuracy is (e.g., the more dissimilar the output performance (or inference performance) of the candidate neural network in which a layer of the succession segment is changed compared to the original neural network 10 is) the lower the importance value for the succession segment may be.

For example, when output accuracy of a first candidate neural network is 85% and the output accuracy of the original neural network 10 is 90%, and when output accuracy of a second candidate neural network is 70% and the output accuracy of the original neural network 10 is 90%, importance of the succession segment of the first candidate neural network may be higher than importance of the succession segment of the second candidate neural network.

In example embodiments, a latency value for the succession segment may be set based on a time consumed to execute (e.g., a time consumed to generate an output based on an input using) the succession segment. A latency value for the non-succession segment may be set based on a time consumed to execute the non-succession segment. In example embodiments, the latency value for the succession segment may correspond to the time consumed to execute the succession segment, and the latency value for the non-succession segment may correspond to the time consumed to execute the non-succession segment.

For example, with Equation 3 described below, the processor 120 may select the candidate neural network of which the value of the sum of the latencies is below the threshold value and the value of the sum of the importance values is largest.

$$A ⊆ max [ L - 1 ] , {k}_{i} {\sum }_{i = 1}^{\vert A \vert + 1} I [ {a}_{i - 1} , {a}_{i} , {k}_{i} ] \qquad Equation 3$$

$$subject to {\sum }_{i = 1}^{\vert A \vert + 1} T [ {a}_{i - 1} , {a}_{i} , {k}_{i} ] < {T}_{0}$$

$${k}_{i} ∈ {K}_{{a}_{i - 1} , {a}_{i}}$$

Here, “A” may be a subset of the neural network 10 and denote the candidate neural network. “L” may denote a depth of the neural network 10. “l” may denote an importance value for a succession segment “aᵢ” in an interval “aᵢ₋₁” to which a kernel size “kᵢ” is set, and “T” may denote a latency value for the succession segment “aᵢ” in the interval “aᵢ₋₁” to which the kernel size “kᵢ” is set. “To” may be an allowable threshold value. “K” may be a set of kernel sizes that may be merged in the succession segment “aᵢ” between in the interval “aᵢ₋₁”.

In example embodiments, the processor 120 may select an optimal candidate neural network among the plurality of candidate neural networks using a dynamic programming algorithm. The dynamic programming algorithm may be an algorithm determining an optimal solution of a current operation based on an optimal solution of a previous operation. By using the dynamic programming algorithm to store a previously determined value in the memory 110 and reuse the determined value without repeating determination of the same part, the processor 120 of one or more embodiments may improve efficiency of the determination. For example, the dynamic programming algorithm may be defined by Equation 4 below, for example.

$$M [ l , t ] = \begin{matrix}max \\ 0 \leq {l}^{′} < l , k ∈ {K}_{{l}^{′} l ,}\end{matrix} ( M [ {l}^{′} , t - T [ {l}^{′} , l , k ] ] + l [ {l}^{′} , l , k ] ) \qquad Equation 4$$

For example, “M[l, t]” may be an optimized importance value using a latency value “t” for a segment up to an index l of the neural network 10. “l′” may denote an index smaller than the index l. “T” may be a latency value for a segment from an index “l′” to the index l to which a kernel size “K” is set. “M[l′,t−T]” may denote an optimized importance value using a latency value “t−T” of a segment up to the index “l′” of the neural network 10.

The processor 120 of one or more embodiments may determine the optimal candidate neural network for maintaining the output performance (or inference performance) while lightweighting the neural network 10.

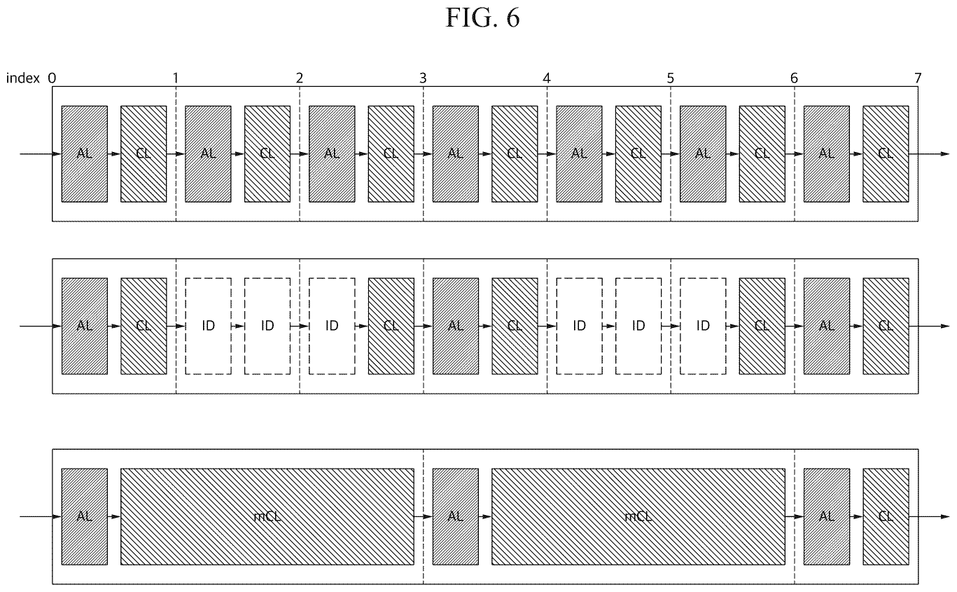

FIG. 6 is a diagram illustrating a process of lightweighting a neural network according to one or more embodiments.

Referring to FIGS. 5 and 6, the processor 120 according to example embodiments may obtain a plurality of candidate neural networks based on the neural network 10. The plurality of candidate neural networks may include a candidate neural network in which at least one nonlinear layer AL is excluded from the neural network 10. The plurality of candidate neural network may include a candidate neural network in which the at least one nonlinear layer AL and at least one convolution layer CL is excluded.

In example embodiments, the processor 120 may select a candidate neural network, of which a value of a sum of latency values of a succession segment and a non-succession segment is below a threshold value, and of which a value of a sum of importance values of the succession segment and the non-succession segment is largest, from the plurality of candidate neural networks. For example, as illustrated in FIG. 6, it may be assumed that the nonlinear layer AL and the convolution layer CL of a second segment, the nonlinear layer AL of a third segment, the nonlinear layer AL and the convolution layer CL of a fifth segment, and the nonlinear layer AL of a sixth segment are excluded from the selected candidate neural network. Here, the excluded layers may be replaced with the identity function layers ID.

In this case, the processor 120 may obtain a final neural network by merging, as one merged layer mCL, the convolution layer CL of a first segment and the convolution layer CL of the third segment which are successive in a first succession segment and merging, as one merged layer mCL, the convolution layer CL of a fourth segment and the convolution layer CL of the sixth segment of which are successive in the fourth segment. The final neural network may be referred to as a lightweight neural network according to example embodiments.

In example embodiments, the processor 120 may adjust a weight value included in the convolution layer by retraining the selected candidate neural network and/or the final neural network. For example, the processor 120 may enhance output performance (e.g., inference, output, and/or prediction performance and/or accuracy) by fine-tuning the selected candidate neural network and/or the final neural network through learning data.

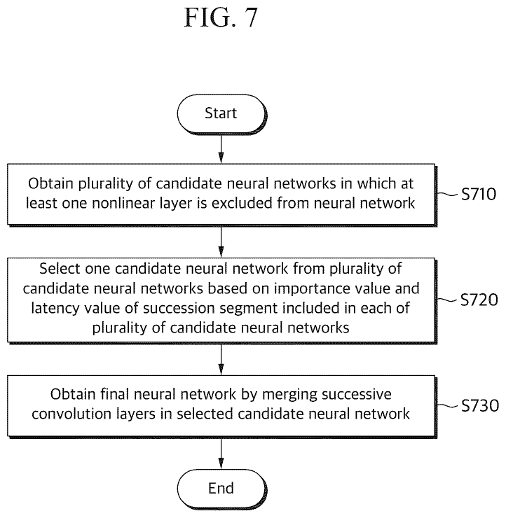

FIG. 7 is a diagram illustrating an operating method for neural network lightweighting according to one or more embodiments. Operations S710 to S730 to be described hereinafter may be performed sequentially in the order and manner as shown and described below with reference to FIG. 7, but the order of one or more of the operations may be changed, one or more of the operations may be omitted, and two or more of the operations may be performed in parallel or simultaneously without departing from the spirit and scope of the example embodiments described herein.

Referring to FIG. 7, the operating method for the neural network lightweighting according to example embodiments may include obtaining a plurality of candidate neural networks in which at least one nonlinear layer is excluded from the neural network 10 including a plurality of segments including a nonlinear layer and a convolution layer in operation S710, selecting one candidate neural network from the plurality of candidate neural networks based on an importance value and a latency value for a succession segment in which convolution layers are successive among a plurality of segments included in each of the plurality of candidate neural networks in operation S720, and obtaining a final neural network by merging the successive convolution layers of the selected candidate neural network in operation S730. Each operation of the operating method for the neural network lightweighting may be performed by the electronic device 100.

In example embodiments, in the operating method for the neural network lightweighting, the plurality of candidate neural networks in which the at least one nonlinear layer is excluded from the neural network 10 may be obtained in operation S710. Here, each candidate neural network may include one or more remaining nonlinear layers, excluding the at least one nonlinear layer from a plurality of layers included in the neural network 10. In example embodiments, each candidate neural network may include the succession segment with the successive convolution layers generated by excluding the at least one nonlinear layer from the plurality of layers included in the neural network 10. In example embodiments, each candidate neural network may include one or more remaining convolution layers, excluding a convolution layer unselected according to a kernel size that is set for the succession segment. In example embodiments, a candidate neural network may include an identity function layer inserted to a location of the excluded layer.

In example embodiments, in the operating method for the neural network lightweighting, the one candidate neural network from the plurality of candidate neural networks may be selected based on the importance value and the latency value for the succession segment in operation S720. For example, in the operating method for the neural network lightweighting, a candidate neural network satisfying that a value of sum of respective latency values of the succession segment and a non-succession segment is below a threshold value and that a value of a sum of respective importance values of the succession segment and the non-succession segment is largest may be selected as the final neural network. For example, the final neural network may be a candidate neural network with highest output performance (e.g., inference performance) among candidate neural networks which have the value of the sum of the latencies below the threshold value. For example, output performance (e.g., inference performance) may be a value indicating a degree to which inferential data that is output from a candidate neural network (e.g., a neural network) is closer to a correct answer. For example, when the number of correct answers is 95 out of 100 pieces of inferential data that are output from one candidate neural network, the output performance (or inference performance) of the candidate neural network may be determined to be a value of 95%, 0.95, or the like.

In the operating method for the neural network lightweighting, the final neural network may be obtained by merging the successive convolution layers in the selected candidate neural network in operation S730. Here, the final neural network may not include a nonlinear layer and a convolution layer excluded from the selected candidate neural network. The final neural network may include a merged layer into which the successive convolution layers included in the succession segment of the selected candidate neural network and may also include a convolution layer of the non-succession segment and a remaining nonlinear layer.

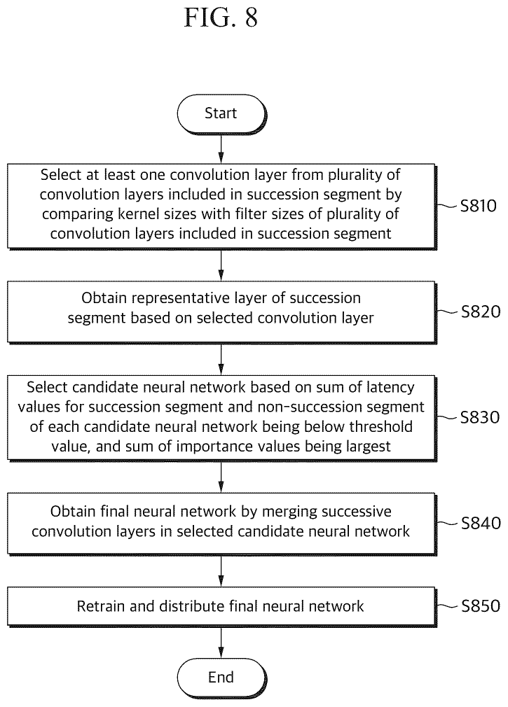

FIG. 8 is a diagram illustrating an operating method for neural network lightweighting according to an one or more embodiments. Operations S810 to S850 to be described hereinafter may be performed sequentially in the order and manner as shown and described below with reference to FIG. 8, but the order of one or more of the operations may be changed, one or more of the operations may be omitted, and two or more of the operations may be performed in parallel or simultaneously without departing from the spirit and scope of the example embodiments described herein.

Referring to FIG. 8, the operating method for the neural network lightweighting according to example embodiments may include selecting at least one convolution layer from a plurality of convolution layers included in a succession segment by comparing filter sizes of the plurality of convolution layers included in the succession segment and a kernel size in operation S810.

In example embodiments, a plurality of candidate neural networks may include a candidate neural network in which a convolution layer unselected from the plurality of convolution layers included in the succession segment is excluded according to a kernel size that is set for the succession segment.

In example embodiments, in the operating method for the neural network lightweighting, when kernel sizes of the plurality of convolution layers included in the succession segment are equal, a convolution layer may be identified based on a value of a sum of weight values included in each of the plurality of convolution layers. In specific example embodiments, in the operating method for the neural network lightweighting, when the kernel sizes of the plurality of convolution layers included in the succession segment are equal, the convolution layer may be selected in sequential order from a largest value among values of respective sums of weight values included in the plurality of convolution layers. In addition, in the operating method for the neural network lightweighting, a remaining convolution layer other than the selected convolution layers may be excluded. For example, in the case that some of the convolution layers included in the succession segment are to be selected based on the kernel size which is set for the succession segment, a convolution layer may be selected in sequential order from the largest value among the values of the respective sums of the weight values included the convolution layers. Also, the unselected convolution layer may be excluded from the succession segment.

The operating method for the neural network lightweighting according to example embodiments may include obtaining (or identifying) a representative layer of the succession segment based on the selected (or identified) convolution layer in operation S820.

In example embodiments, in the operating method for the neural network lightweighting, when at least two convolution layers are selected (or identified) from the plurality of convolution layers included in the succession segment, a merged layer into which the selected (or identified) convolution layers are merged may be obtained as the representative layer.

In example embodiments, in the operating method for the neural network lightweighting, when one convolution layer is selected (or identified) from the plurality of convolution layers, the selected (or identified) convolution layer may be obtained as the representative layer.

In example embodiments, the operating method for the neural network lightweighting may include selecting a candidate neural network from among the plurality of candidate neural networks, based on a sum of latency values for the succession segment and a non-succession segment of each candidate neural network being below a threshold value, and a sum of importance values for the succession segment and the non-succession segment being largest, in operation S830.

In example embodiments, the operating method for the neural network lightweighting may further include an operation of obtaining a value corresponding to output accuracy of each candidate neural network and a variation of output accuracy of a neural network as an importance value for the succession segment of each candidate neural network.

In example embodiments, the importance value for the succession segment of each candidate neural network may have a large value as the variation for the succession segment decreases.

In example embodiments, the operating method for the neural network may further include an operation of obtaining a value corresponding to a time consumed to determine each of the succession segment and the non-succession segment as a latency value for each of the succession segment and the non-succession segment.

In example embodiments, the operating method for the neural network lightweighting may include an operation of obtaining a final neural network by merging successive convolution layers in the selected candidate neural network in operation S840.

In example embodiments, the operating method for the neural network lightweighting may include an operation of retraining and distributing the final neural network in operation S840. In example embodiments, in the operating method for the neural network lightweighting, a weight value included in a convolution layer may be adjusted by retraining the selected candidate neural network or the final neural network. In example embodiments, the operating method for the neural network lightweighting, the retrained final neural network may be distributed by transmitting the retrained final neural network to an external device.

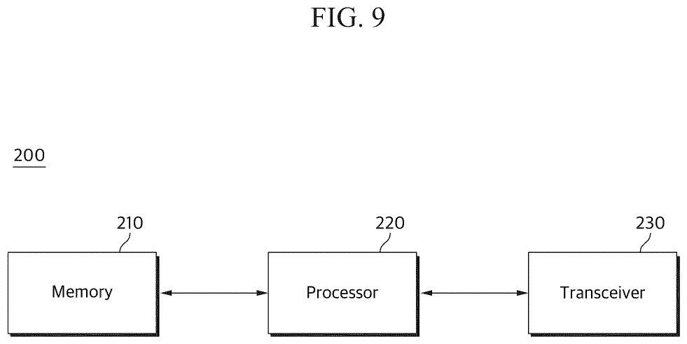

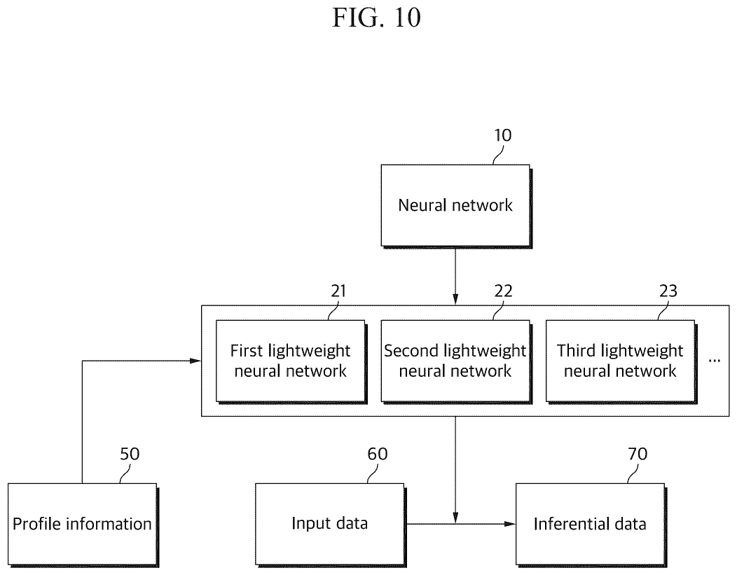

FIG. 9 is a block diagram of a terminal according to one or more embodiments. FIG. 10 is a diagram illustrating a data flow according to one or more embodiments.

Referring to FIGS. 9 and 10, a terminal 200 according to example embodiments may include a memory 210 (e.g., one or more memories), a processor 220 (e.g., one or more processors), and a transceiver 230. The terminal 200 may be at least one of a smartphone, a tablet, a computer, a smart watch, a smart glasses, a smart ring, a gaming console, a smart television (TV), a virtual reality device, an augmented reality device, a mixed reality device, a wearable device, an infotainment system for a vehicle, and others. However, it is merely an example and various types of user devices may be implemented as the terminal 200.

In example embodiments, the memory 210 may include at least one of various types of storage devices such as a RAM, an HBM, a flash memory, a hard disk drive, a solid-state drive, and a cache memory.

The memory 210 may store data. In example embodiments, the memory 210 may store the neural network 10. The memory 210 may store a plurality of lightweight neural networks 21 to 23. The plurality of lightweight neural networks 21 to 23 may be obtained by lightweighting the neural network 10 according to the above-described operating method for neural network lightweighting. In example embodiments, each of the plurality of lightweight neural networks 21 to 23 may be data smaller than the neural network 10 in size. For example, each of the plurality of the lightweight neural networks 21 to 23 may have a data size of hundreds of megabytes, and the neural network 10 may have a data size of several gigabytes. The data size of each of the plurality of lightweight neural networks 21 to 23 may decrease as a degree of lightweighting increases. However, it is merely an example, and a size of data may be varied.

The processor 220 may control overall operations of the terminal 200 or carry out operations. For example, the processor 220 may execute a program or an instruction stored in the memory 210. For example, the memory 210 may be or include a non-transitory computer-readable storage medium storing code that, when executed by the processor 220, configures the processor 220 to perform any one, any combination, or all of operations and/or methods disclosed herein with reference to FIGS. 1-10. The processor 220 may process the data (e.g., the neural network 10) stored in the memory 210 or carry out operations. The processor 220 may include at least one processing device from a central processing unit (CPU), a graphics processing unit (GPU), a neural processing unit (NPU), a micro controller unit (MCU), and an application processor (AP).

The processor 220 may identify a target lightweight neural network corresponding to profile information 50 among the plurality of lightweight neural networks 21 to 23. The lightweight neural networks 21 to 23 may be received from the electronic device 100 or generated by the processor 220.

The transceiver 230 may receive and transmit information through communication with an external device. In example embodiments, the transceiver 230 may receive the neural network 10 from the electronic device 100. In example embodiments, the transceiver 230 may receive at least one of the plurality of lightweight neural networks 21 to 23. In example embodiments, the transceiver 230 may transmit the profile information 50. The profile information 50 may include one of user information and performance information.

The terminal 200 according to an example embodiment may include the transceiver 230 and the processor 220.

The transceiver 230 may communicate with the electronic device 100. The electronic device 100 may store at least one of the neural network 10 and the plurality of lightweight neural networks 21 and 23. The neural network 10 may include a plurality of segments. Each segment may include a nonlinear layer and a convolution layer. The plurality of lightweight neural networks 21 to 23 may be obtained by performing the operating method for the neural network lightweighting for the neural network 10. For example, the plurality of lightweight neural networks 21 to 23 may be obtained by performing the operating method for the neural network lightweighting and changing a threshold value. For example, the electronic device 100 may prepare in advance and store various types of the lightweighted lightweight neural networks 21 to 23 of the neural network 10.

The plurality of lightweight neural networks 21 to 23 may have different degrees of lightweighting a layer in the neural network 10. The plurality of lightweight neural networks 21 to 23 may have different latencies. The plurality of lightweight neural networks 21 to 23 may have different inference performance. For example, as a degree of the lightweighting becomes larger, each of the lightweight neural networks 21 to 23 may have a lower latency (namely, a higher inference speed) and lower inference performance (namely, lower inference accuracy). A higher latency may indicate a large computational load. For example, the plurality of lightweight neural networks 21 to 23 may include various types from a lightweight neural network with high inference performance and a large computational load to a lightweight neural network with low inference performance and a small computational load.

In example embodiments, each of the plurality of lightweight neural networks 21 to 23 may correspond to one of a plurality of threshold values that are different from each other. For example, a threshold value may be set to be any one of 10%, 20%, 30%, 40%, 50%, 60%, 70%, 80%, and 90% of a latency value for the neural network 10. However, this is merely an example embodiment and the number and setting values of the threshold values may be varied. One lightweight neural network may be determined for each threshold value. Each of the plurality of the lightweight neural networks 21 to 23 may be a candidate neural network with the highest inference performance among a plurality of candidate neural networks having latencies smaller than a corresponding threshold value among the plurality of threshold values. In example embodiments, each of the plurality of the candidate neural networks may include a merged layer in which at least one nonlinear layer is excluded from the neural network 10 and into which convolution layers of a segment succeeding or succeeded by a segment from which the nonlinear layer is excluded are merged. For example, a candidate neural network may selectively include a part of a plurality of nonlinear layers included in the neural network 10 and may include a merged layer into which successive convolution layers are merged and convolution layers that are not successive.

The processor 220 may control the transceiver 230 to transmit the profile information 50 to the electronic device 100. For example, the processor 220 may control the transceiver 230 to transmit the profile information 50 to the electronic device 100 when input data 60 for obtaining inferential data 70 is received. The input data 60 may be in the form of a text such as a message and a number, an image, a voice, a video, a document, or the like.

In example embodiments, the profile information 50 may include at least one of the performance information and the user information. For example, the performance information may be information on performance of the terminal 200. The user information may be information on a user or an account.

In example embodiments, the performance of the terminal 200 may correspond to a threshold value. For example, as the performance of the terminal 200 becomes higher, a higher threshold value may correspond thereto. For example, the threshold value may be determined by the performance of the terminal 200. In example embodiments, a lightweight neural network may correspond to the performance of the terminal 200. For example, as the performance of the terminal 200 becomes higher, a lightweight neural network that has a high latency and/or high inference performance may correspond thereto. For example, the lightweight neural network may be determined according to the performance of the terminal 200.

In example embodiments, the performance of the terminal 200 may include at least one of a load of the processor 220 and a storage capacity of the memory 210. For example, the load of the processor 220 may indicate a clock rate, a bandwidth, the number of cores, a processing capability according to a work schedule of the processor 220, and/or the like. The storage capacity of the memory 210 may indicate a current storage capacity. In example embodiments, the user information may be information corresponding to one of access levels. One access level may be assigned according to a fee rate. For example, as an amount of a fee rate paid by the user becomes higher, a higher access level may be assigned.

In example embodiments, the performance or the access level may correspond to one of a plurality of levels that are divided in advance (e.g., a first level, a second level, and a third level). For example, the third level may be higher than the second level, and the second level may be higher than the first level. For example, in the case of the performance, the third level may be a high level, the second level may be a middle level, and the third level may be a low level. For example, in the case of the access level, the third level may be a premium level, the second level may be a standard level, and the first level may be a basic level. However, this is merely an example embodiment, and the levels may be varied and implemented.

The processor 220 may receive a lightweight neural network that corresponds to the profile information 50 among the plurality of lightweight neural networks 21 to 23 through the transceiver 230. For example, when the profile information 50 is received, the electronic device 100 may transmit one lightweight neural network that corresponds to the profile information 50 among the plurality of lightweight neural networks to the transceiver 230.

In example embodiments, the processor 220 may receive a first lightweight neural network 21 when the performance of the terminal 200 corresponds to the first level. In example embodiments, the first lightweight neural network 21 may be a lightweight neural network corresponding to the first level among the plurality of lightweight neural networks 21 to 23. In example embodiments, the first lightweight neural network 21 may be a lightweight neural network with a latency smaller than a threshold value among the plurality of lightweight neural networks 21 to 23. In example embodiments, the processor 220 may receive a second lightweight neural network 22 when the performance corresponds to the second level. In example embodiments, the second lightweight neural network 22 may be a lightweight neural network corresponding to the second level among the plurality of lightweight neural networks 21 to 23. In example embodiments, the second lightweight neural network 22 may be a lightweight neural network with a latency smaller than a threshold value corresponding to the second level of the plurality of lightweight neural networks 21 to 23.

Here, the second level may be higher than the first level. The second lightweight neural network 22 may have higher inference performance than that of the first lightweight neural network 21. In example embodiments, the second lightweight neural network 22 may have a higher latency than that of the first lightweight neural network 21.

In example embodiments, the processor 220 may receive the first lightweight neural network 21 when the access level corresponds to the first level. The first lightweight neural network 21 may be a lightweight neural network corresponding to the first level among the plurality of lightweight neural networks 21 to 23. In example embodiments, the processor 220 may receive the second lightweight neural network 22 when the access level corresponds to the second level. The second lightweight neural network 22 may be a lightweight neural network corresponding to the second level among the plurality of lightweight neural networks 21 to 23.

Here, the second level may be higher than the first level. The second lightweight neural network 22 may have the higher inference performance than that of the first lightweight neural network 21. In example embodiments, the second lightweight neural network 22 may have the latency higher than that of the first lightweight neural network 21.

The processor 220 may obtain the inferential data 70 based on the received lightweight neural network. The lightweight neural network may be received from the electronic device 100. The lightweight neural network may be stored in the memory 210. For example, the processor 220 may obtain the inferential data 70 by determining the lightweight neural network to which the input data 60 is input.

The terminal 200 according to an example embodiment may include the transceiver 230 and the processor 220.

The transceiver 230 may communicate with the electronic device 100. The electronic device 100 may store the neural network 100 including the plurality of segments. Each of the plurality of segments may include the nonlinear layer and the convolution layer.

The processor 220 may control the transceiver 230 to transmit performance information on the terminal 200 to the electronic device 100. The above description may be identically applied to the performance information. For example, the processor 220 may control transceiver 230 to transmit the performance information to the electronic device 100 when the input data 60 for obtaining the inferential data 70 is received.

The processor 220 may receive a lightweight neural network corresponding to the performance information from the electronic device 100 through the transceiver 230. Here, the lightweight neural network may have a latency smaller than a threshold value corresponding to the performance of the terminal 200 through lightweighting the neural network 10 by excluding the nonlinear layer and merging convolution layers. The above description may be identically applied to the lightweight neural network. The processor 220 may obtain the inferential data 70 based on the received lightweight neural network.

The terminal 200 according to an example embodiment may include the memory 210 and the processor 220.

The memory 210 may store the neural network 10 including the plurality of segments and the plurality of lightweight neural networks 21 to 23. Each of the plurality of segments may include the nonlinear layer and the convolution layer. The plurality of lightweight neural networks 21 to 23 may have the different degrees of lightweighting the layer in the neural network 10 and the different latencies.

The processor 220 may identify a lightweight neural network corresponding to the performance of the terminal 200 among the plurality of lightweight neural networks 21 to 23 as a final neural network.

In example embodiments, the performance of the terminal 200 may include at least one of the load of the processor 220 and the storage capacity of the memory 210. For example, the load of the processor 220 may indicate the clock rate, the bandwidth, the number of the cores, the processing capability according to the work schedule of the processor 220, or the like. The storage capacity of the memory 210 may indicate the current storage capacity.

In example embodiments, when the performance of the terminal 200 corresponds to the first level, the processor 220 may identify the first lightweight neural network 21 corresponding to the first level among the plurality of lightweight neural networks 21 to 23 as the final lightweight neural network. In example embodiments, when the performance of the terminal 200 corresponds to the second level, the processor 220 may identify the second lightweight neural network corresponding to the second level among the plurality of lightweight neural networks 21 to 23 as the final lightweight neural network.

Here, the second level may be higher than the first level. The second lightweight neural network 22 may have the higher inference performance than that of the first lightweight neural network 21. In example embodiments, as the performance of the terminal 200 increases, a lightweight neural network with a higher latency may be determined to be the final lightweight neural network.

The processor 220 may obtain the inferential data 70 based on the final lightweight neural network. For example, the processor 220 may obtain the inferential data 70 by determining the final lightweight neural network to which the input data 60 is input.

According to an example embodiment of the present disclosure, when performance or a budget determined for the terminal 200 dynamically changes at a latency (or inference time), an optimal lightweight neural network may be provided accordingly.

In example embodiments, when the user uses a first terminal with the memory 210 or the processor 220 that has low performance such as a mobile device, the inferential data 70 may be obtained through the first lightweight neural network 21 with low inference performance and a low latency. Then, when the user uses a second terminal with higher performance using the same account such as a computer, the inferential data 70 may be obtained through the second lightweighting neural network 22 with the higher inference performance and the higher latency. In this case, when the second lightweight neural network 22 is determined in the first terminal with the low performance, a large amount of time may be required. However, when the second lightweight neural network 22 is determined in the second terminal with the higher performance, a smaller amount of time may be required, and vice versa.

In example embodiments, when the user pays the fee rate, a service provider distributing different types of the lightweight neural networks 21 to 23 may provide, to the user, a lightweight neural network corresponding to the access level that is assigned according to the amount of the fee rate paid by the user. For example, as the amount of the fee rate paid by the user becomes larger, a higher access level may be assigned. In this case, the service provider may provide a lightweight neural network with higher inference performance to a user that has paid a high fee rate and provide a lightweight neural network with low inference performance to a user that has paid a low fee rate. For example, inference performance of the lightweight neural network may be differentiated depending on payment by the user.

The electronic device 100 in accordance with the above-described example embodiments may include the processor 120, the memory 110 which stores and executes program data, a communication port for communication with an external device, and a user interface device such as a touch panel, a key, and a button. Methods realized by software modules or algorithms may be stored in a computer-readable recording medium as computer-readable codes or program commands which may be executed by the processor. Here, the computer-readable recording medium may be a magnetic storage medium (e.g., a read-only memory (ROM), a random-access memory (RAM), a floppy disk, or a hard disk) or an optical reading medium (e.g., a CD-ROM or a digital versatile disc (DVD)). The computer-readable recording medium may be dispersed to computer systems connected by a network so that computer-readable codes may be stored and executed in a dispersion manner. The medium may be read by a computer, may be stored in a memory, and may be executed by the processor.

The electronic devices, memories, processors, terminals, transceivers, electronic device 100, memory 110, processor 120, terminal 200, memory 210, processor 220, and transceiver 230 described herein, including descriptions with respect to respect to FIGS. 1-10, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in, and discussed with respect to, FIGS. 1-10 that perform the operations described in this application are performed by computing hardware, for example, by one or more processors or computers, implemented as described above implementing instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. An electronic device comprising:
one or more processors configured to:
generate a plurality of candidate neural networks in which one or more nonlinear layers are excluded from a neural network including a plurality of segments, each of the plurality of segments including a nonlinear layer and a convolution layer;
select one candidate neural network from the plurality of candidate neural networks based on an importance value and a latency value for a succession segment included in each of the plurality of candidate neural networks where convolution layers are successive; and
generate a final neural network in which the successive convolution layers are merged in the selected candidate neural network.

2. The electronic device of claim 1, wherein the plurality of candidate neural networks comprises a candidate neural network in which a predetermined convolution layer is excluded from a plurality of convolution layers included in the succession segment according to a kernel size that is set for the succession segment.

3. The electronic device of claim 2, wherein, for the selecting of the one candidate neural network from the plurality of candidate neural networks, the one or more processors are configured to:
identify one or more convolution layers among the plurality of convolution layers included in the succession segment by comparing the kernel size which is set for the succession segment with kernel sizes of the plurality of convolution layers included in the succession segment;
identify a representative layer of the succession segment based on the identified convolution layer; and
select a candidate neural network from among the plurality of candidate neural networks, in which the plurality of convolution layers included in the succession segment are replaced with the representative layer, based on a sum of latency values for the succession segment and a non-succession segment in each candidate neural network being below a threshold value, and a sum of importance values for the succession segment and the non-succession segment being largest.

4. The electronic device of claim 3, wherein, for the identifying of the representative layer, the one or more processors are configured to generate, in response to identifying two or more convolution layers from the plurality of the convolution layers included in the succession segment, a merged layer into which the selected convolution layers are merged as the representative layer.

5. The electronic device of claim 3, wherein the one or more processors are configured to generate, in response to identifying only one convolution layer from the plurality of convolution layers included in the succession segment, the selected convolution layer as the representative layer.

6. The electronic device of claim 3, wherein the one or more processors are configured to, in response to the kernel sizes of the plurality of convolution layers included in the succession segment being equal:
select a convolution layer in sequential order from a largest value among respective sums of weight values included in the plurality of convolution layers; and
exclude a convolution layer other than the selected convolution layer from the succession segment.

7. The electronic device of claim 2, wherein the importance value for the succession segment of each candidate neural network is set based on output accuracy of each candidate neural network and a variation of the output accuracy of the neural network.

8. The electronic device of claim 7, wherein the importance value for the succession segment of each candidate neural network is set to have a larger value as the variation for the succession segment decreases.

9. The electronic device of claim 3, wherein the latency value for the succession segment is set based on a time consumed to execute the succession segment, and
a latency value for the non-succession segment is set based on a time consumed to execute the non-succession segment.

10. The electronic device of claim 1, wherein the one or more processors are configured to adjust a weight value included in the convolution layer by retraining the selected candidate neural network or the final neural network.

11. The electronic device of claim 1, wherein
the final neural network is a target lightweight neural network corresponding to profile information among a plurality of lightweight neural networks having different degrees of lightweighting a layer in the neural network and different latencies, and
the one or more processors are configured to obtain inferential data based on the target lightweight neural network.

12. A processor-implemented method comprising:
generating a plurality of candidate neural networks in which one or more nonlinear layers are excluded from a neural network including a plurality of segments, each of the plurality of segments including a nonlinear layer and a convolution layer;
selecting one candidate neural network from the plurality of candidate neural networks based on an importance value and a latency value for a succession segment included in each of the plurality of candidate neural networks where convolution layers are successive; and
generating a final neural network in which the successive convolution layers are merged in the selected candidate neural network.

13. The method of claim 12, wherein the plurality of candidate neural networks includes a candidate neural network in which a predetermined convolution layer is excluded from a plurality of convolution layers included in the succession segment according to a kernel size which is set for the succession segment.

14. The method of claim 13, wherein the selecting of the one candidate neural network from the plurality of candidate neural networks comprises:
identifying one or more convolution layers among the plurality of convolution layers included in the succession segment by comparing the kernel size which is set for the succession segment with kernel sizes of the plurality of convolution layers included in the succession segment;
identifying a representative layer of the succession segment based on the identified convolution layer; and
selecting a candidate neural network from among the plurality of candidate neural networks, in which the plurality of convolution layers included in the succession segment are replaced with the representative layer, based on a sum of latency values for the succession segment and a non-succession segment in each candidate neural network being below a threshold value, and a sum of importance values for the succession segment and the non-succession segment being largest.

15. The method of claim 14, wherein the identifying of the one or more convolution layers from the plurality of convolution layers included in the succession segment comprises, in response to the kernel sizes of the plurality of the convolution layers included in the succession segment being equal:
selecting a convolution layer in sequential order from a largest value among values of respective sums of weight values included in the plurality of convolution layers; and
excluding a convolution layer other than the selected convolution layer from the succession segment.

16. The method of claim 13, further comprising obtaining a value that is set based on output accuracy of each candidate neural network and a variation of the output accuracy of the neural network as the importance value for the succession segment of each candidate neural network.

17. The method of claim 16, wherein the importance value for the succession segment of each candidate neural network is set to have a larger value as the variation for the succession segment decreases.

18. A terminal for communicating with an electronic device that stores a neural network, the terminal comprising:
a transceiver configured to receive and transmit information to and from the electronic device; and
one or more processors configured to:
generate a target lightweight neural network corresponding to profile information among a plurality of lightweight neural networks having different degrees of lightweighting a layer in the neural network and different latencies; and
obtain inferential data based on the target lightweight neural network.

19. The terminal of claim 18, wherein the one or more processors are configured to:
generate, in response to performance of the terminal included the profile information corresponding to a first level, a first lightweight neural network that has a smaller latency than a threshold value corresponding to the first level among the plurality of lightweight neural networks as the target lightweight neural network; and
generate, in response to the performance corresponding to a second level that is higher than the first level, a second lightweight neural network that has a smaller latency than a threshold value corresponding to the second level among the plurality of lightweight neural networks as the target neural network, and
the second lightweight neural network has higher inference performance than that of the first lightweight neural network.

20. The terminal of claim 18, wherein the one or more processors are configured to:
receive, in response to an access level of the terminal included the profile information corresponding to a first level, a first lightweight neural network corresponding to the first level among the plurality of lightweight neural networks as the target lightweight neural network; and
receive, in response to the access level corresponding to a second level that is higher than the first level, a second lightweight neural network among the plurality of lightweight neural networks as the target lightweight neural network, and
the second lightweight neural network has higher inference performance than that of the first lightweight neural network.
